(19) United States
(12) Patent Application Publication
(10) Pub. No.: US 2022/0035598 A1
(43) Pub. Date: Feb. 3, 2022

(54) Random Symbol Generation System and Method

(71) Applicants: Andrew Pomerance, Alexandria, VA (US); Colin McCann, Arlington, VA (US)

(72) Inventors: Andrew Pomerance, Alexandria, VA (US); Colin McCann, Arlington, VA (US)

(21) Appl. No.: 17/297,894

(22) PCT Filed: Nov. 29, 2019
(86) PCT No.: PCT/US19/63841

§ 371 Date: May 27, 2021

Related U.S. Application Data
(60) Provisional application No. 62/772,529, filed on Nov. 28, 2018.

(51) Int. Cl. G06F 7/58; G06F 7/556; G06N 7/08

(52) U.S. Cl. CPC G06F 7/588; G06N 7/08; G06F 7/556

(57) ABSTRACT

A method (200) for evaluating random symbols includes generating random symbols from a chaotic system (210), evaluating an output of the chaotic system by a raw entropy estimator and by a Lyapunov exponent estimator (220) and verifying a plurality of parameters based on the on the outputs of the raw entropy estimator and the Lyapunov exponent estimators (230).

### CLAIM FOR PRIORITY

This application claims the benefit of the filing date of U.S. Provisional Application No. 62/772,529 filed on Nov. 28, 2018. The subject matter of the provisional application is incorporated herein in its entirety by reference.

### BACKGROUND

The present disclosure is directed to true random number generators. Random numbers are used in electronic applications such as in chip cards. The random nature of the numbers provide a basis for encrypting data—that is, random numbers are used for encryption and/or cryptography.

Random number generators, or RNGs, are hardware devices or software programs that produce a sequence of unpredictable numbers or symbols as its output. Software-based RNGs are known as pseudo-random number generators because the output, while unpredictable to outside observers, is a deterministic function of the hidden state of the software program. True RNGs, however, are hardware devices that produce numbers from physical measurements (such as voltage) of a physical system that has a theoretical basis for random or unpredictable behavior, such as quantum mechanics or chaos theory.

A parameter upon which the quality of a random number sequence is evaluated is the entropy per symbol. In a physical context, entropy is the measurement of uncertainty or disorder in a system. This is related to an information theory concept of entropy, which is how much information is required to describe the system. Highly disordered, uncertain, and unpredictable systems require more information to fully describe them than highly ordered systems. True RNGs harness the unpredictability of the physical system to produce random symbols.

The units of entropy are bits. In the case when a true RNG produces a sequence of either zeros or ones randomly, with equal probability and independently of each other, the entropy per symbol is 1 bit/symbol. In general, if the RNG produces symbols that are integers uniformly and independently drawn from between zero and 2^{N} for some value of N (that is, there are N bits in the binary representation of the integer), the entropy is N bits/symbol. Biases in the produced symbols (e.g. more zeros than ones are produced by an RNG that produces only binary digits) as well as correlations between successive symbols can lower the entropy per symbol from the ideal values. A higher entropy makes it harder for an attacker to guess the random number sequence. Therefore, methods and systems for generating random numbers with a higher entropy are desirable.

An important consideration when designing true RNGs is to have a robust theory of operation that provides a sound basis for entropy production claims. The present invention is related to true RNGs that have deterministic chaos as their theoretical basis. Examples of deterministic chaotic systems that can be harnessed for true RNGs are some electronic circuits and some lasers when operated in certain modes. An important quantity describing a chaotic system is the largest Lyapunov exponent, which is the rate at which initially close systems diverge. Because of the relationship between unpredictability of a physical system and information content, this provides a lower bound on the entropy rate of the system, as measured in bits per second. This quantity helps the RNG designer choose an appropriate symbol size (that is, the number of bits to use in the measurement of the chaotic system) as well as the rate at which to sample the system. The entropy estimate per unit time, calculated from theoretical considerations, can thus be converted into an entropy per symbol estimate that can be experimentally verified by an independent certification body. This entropy per symbol estimate is the “advertised” entropy rate.

In addition to having a robust theory of operation, another important aspect to designing true RNGs is to have a “health check” function, which tests whether the RNG is behaving as expected and that the symbols can be trusted to contain the advertised amount of entropy. The present invention is related to this health check function. It measures the Lyapunov exponent of the underlying system and compares it to the observed entropy per symbol as well as the advertised rate.

The terms “number(s)” and “symbol(s)” are used interchangeably within this disclosure. These terms may refer to the same parameter.

### SUMMARY

According to an exemplary embodiment, a method for evaluating random numbers is disclosed. The method comprises: generating random symbols from a chaotic system; evaluating an output of the chaotic system by a raw entropy estimator and by a Lyapunov exponent estimator; and verifying a plurality of parameters based on the outputs of the raw entropy estimator and the Lyapunov exponent estimators.

According to another embodiment, a system for evaluating random numbers is disclosed. The system comprises: a chaotic system for generating random symbols; a raw entropy estimator for evaluating an output of the chaotic system; a Lyapunov exponent estimator for evaluating the output of the chaotic system; and a consistency checker for verifying a plurality of parameters based on the outputs of the entropy and Lyapunov exponent estimators.

According to a further embodiment a method for encrypting data is disclosed. The method comprises: generating random symbols from a chaotic system; evaluating an output of the chaotic system by a raw entropy estimator and by a Lyapunov exponent estimator; verifying a plurality of parameters based on the outputs of the raw entropy estimator and the Lyapunov exponent estimators; selectively utilizing generated symbols based on the verification to encrypt data.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a system in accordance with exemplary embodiments; and

FIG. 2 illustrates a method in accordance with exemplary embodiments.

### DETAILED DESCRIPTION

In the following description, numerous specific details are given to provide a thorough understanding of exemplary embodiments. The embodiments can be practiced without one or more of the specific details, or with other methods, components, etc. In other instances, well-known structures, or operations are not shown or described in detail to avoid obscuring aspects of the exemplary embodiments.

Reference throughout this specification to an “exemplary embodiment” or “exemplary embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

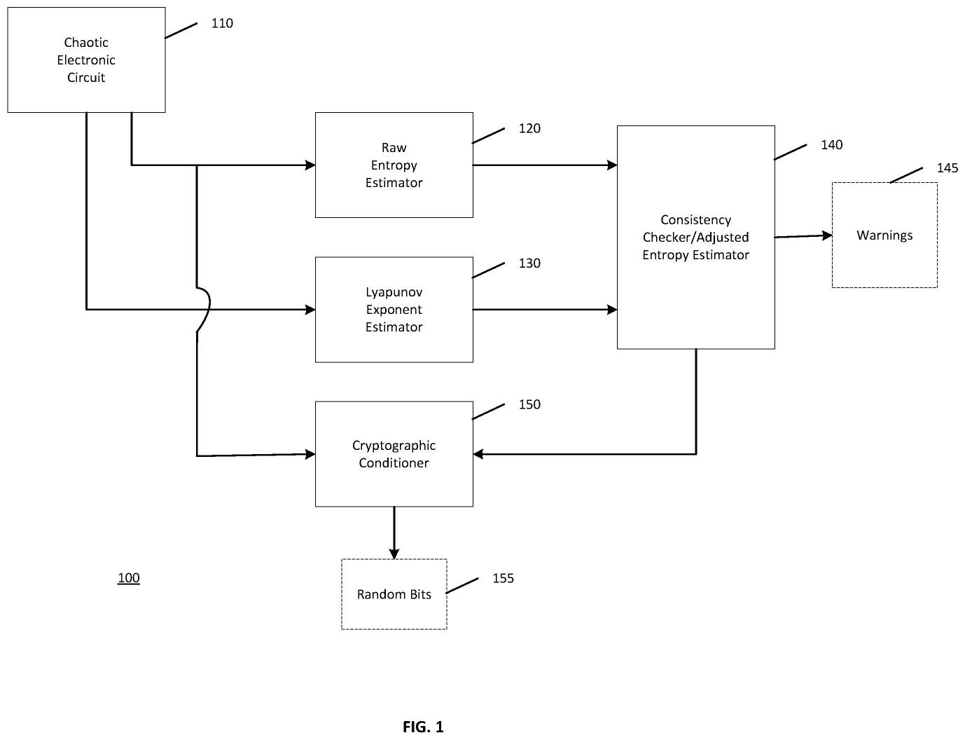

A system 100 for generating random numbers is described in accordance with exemplary embodiments. As illustrated in FIG. 1, system 100 comprises a chaotic system 110, a raw entropy estimator 120, a Lyapunov exponent estimator 130, a consistency checker (or adjusted entropy estimator) 140 and a cryptographic conditioner 150. Each of the elements of system 100 can be implemented on reconfigurable computing platforms such as field programmable gate arrays (FPGAs).

Chaotic system 110 can be an electronic system that may be implemented on a FPGA in some embodiments. System 110 can be an optoelectronic system such as a laser for example. System 110 may be a source for random symbols. Such generation can occur at a frequency f₁₁₀ which can range from 100 MHz to 10 GHz. The frequency can vary based on the nature of the underlying chaotic system as well as the application for which random numbers are generated.

The output of system 110 can be evaluated by a raw entropy estimator circuit 120. Evaluating the entropy of random symbols from a chaotic source is, by itself, known. According to exemplary embodiments, entropy estimator 120 may operate at a frequency f₁₂₀ that may be equal to or lower than the frequency at which chaotic circuit 110 generates random symbols. That is, f₁₂₀≤f₁₁₀. The output of entropy estimator 120 is an entropy estimate expressed in bits per symbol. As highlighted above, a higher entropy estimate indicates a higher degree of randomness which is desirable for most applications.

Concurrently, the output of system 110 may also be evaluated by a Lyapunov exponent estimator 130. The construction of the Lyapunov exponent estimator is dependent on the nature of the chaotic system used as the entropy source. The Lyapunov exponent estimator may make measurements of the chaotic system at a frequency f₁₃₀ that may be equal, but usually higher, than the frequency at which chaotic circuit 110 generates numbers. The output frequency of the Lyapunov exponent estimator is at least the frequency of the random number generation of chaotic electronic circuit 110. That is, f₁₃₀≥f₁₁₀.

The output of Lyapunov exponent estimator 130 is a Lyapunov exponent measured in bits per second. A higher estimate indicates a higher degree of chaos in the system. Estimator 130 keeps a buffer of the states of the chaotic system 110 in the past. How the state is measured and buffered depends on the nature of the chaotic system 110.

As the system evolves, the current state is compared to states in the buffer to find examples when the chaotic system was in a state close to the current state. If a state in the buffer is found that is close to the current state, the time evolution of the distance is calculated. The time evolution of this divergence is averaged over many instances. Periodically, the buffers and running averages may be cleared in order to capture the current dynamics of the system.

If the system 110 is chaotic, this distance is expected, on average, to quickly grow in an exponential manner After averaging the divergence over time, estimator 130 extracts the time constant that governs the exponential divergence. When the base of the exponential function is 2, the units of the Lyapunov exponent is bits per second to that it can be compared to the raw entropy estimator. The output frequency of Lyapunov exponent estimator 130 may be matched to the output frequency of circuit 120.

The outputs of both the raw entropy estimator 120 and Lyapunov exponent estimator 130 may be provided to consistency checker 140 which may produce an adjusted entropy rate. Consistency checker 140 may verify a plurality of parameters based on the outputs of estimators 120 and 130. Checker 140 may verify that the output of estimator 120 is greater than or equal to the advertised rate. Consistency checker 140 may also verify that the output of estimator 130 is within a pre-specified range of the expected Lyapunov exponent.

That is, for example, if theoretical considerations and laboratory testing indicate that the Lyapunov exponent of the chaotic system is 3 bits/ns, the consistency checker will indicate that the system is healthy if the measured Lyapunov exponent is between 2.8 and 3.2 bits/ns. The specific baseline exponent and tolerance depends on, e.g., operating temperature, voltage and manufacturing variances. Significant deviations, however, indicate that the system is not behaving as expected and that the output symbols should not be trusted for sensitive applications.

Checker 140 may further verify that the actual entropy per symbol of estimator 130 is greater than or equal to the predicted entropy per symbol of estimator 130. For example, if the measured Lyapunov exponent is 3 bits/ns, the symbol size is 16 bits (that is, the RNG produces values between 0 and 65536), and the system is sampled at 200 MHz (that is, a random symbol is generated every 5 ns), the entropy measured by the raw entropy estimator must be above 15 bits/symbol.

The output of chaotic electronic circuit 110 may simultaneously be provided to cryptographic conditioner 150 at the same frequency as the frequency of raw entropy estimator 120. Cryptographic conditioning of random numbers generated by a true RNG, by itself, known.

If any one of these (three) conditions evaluated by consistency checker 140 is not satisfied, the generated random number(s) may be considered to have inadequate randomness or that there is a malfunction in the system such that it is not behaving as expected and a warning may be issued at 145.

On the other hand, if all three conditions are satisfied, consistency checker 140 indicates to cryptographic conditioner 150 that the randomness of generated numbers equals or exceeds a desired entropy level. In this case, the generated numbers may be utilized at 155.

The generated number/symbols may be used for encrypting data in order to enhance security of the data.

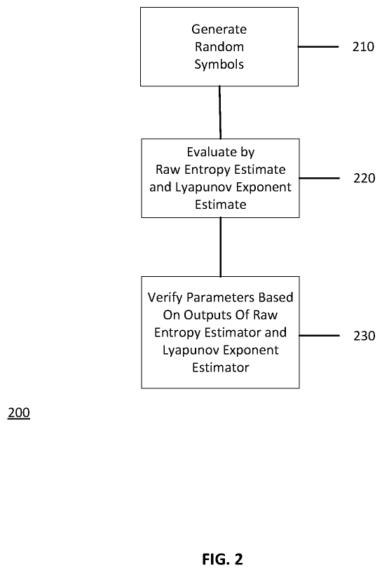

A method in accordance with exemplary embodiments is illustrated in FIG. 2. In method 200, random symbols may be generated at 210. The generated symbols may be evaluated by a plurality of estimators at 220. A plurality of parameters may be verified based on outputs of the plurality of estimators at 230.

The estimators may include a raw entropy estimator and a Lyapunov exponent estimator. The evaluation may take place concurrently using multiple processors such as parallel processors for example.

Exemplary systems and methods described above can be implemented on reconfigurable computing platforms such as field programmable gate arrays (FPGAs).

While the foregoing disclosure enables one of ordinary skill to make and use what is considered presently to be the best mode thereof, those of ordinary skill will understand and appreciate the existence of variations, combinations, and equivalents of the specific embodiment, method, and examples herein. The description should therefore not be limited by the above described embodiments, methods and examples, but by all embodiments and methods within the scope and spirit of the disclosure. All such embodiments are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method (200) for evaluating random symbols comprising:
generating (210) random symbols from a chaotic system;
evaluating (220) an output of the chaotic system by a raw entropy estimator and by a Lyapunov exponent estimator; and
verifying (230) a plurality of parameters based on the on the outputs of the raw entropy estimator and the Lyapunov exponent estimators.

2. The method of claim 1, further comprising:
selectively utilizing the generated symbols based on the verification.

3. The method of claim 1, further comprising:
concurrently evaluating the output of the chaotic system by the raw entropy estimator and the Lyapunov exponent estimator.

4. The method of claim 1, further comprising:
matching an output frequency of the Lyapunov exponent estimator to an output frequency of the raw entropy estimator.

5. The method of claim 1, further comprising:
operating the raw entropy estimator at a frequency less than or equal to a frequency of operation of the chaotic source.

6. The method of claim 1, further comprising:
operating the Lyapunov exponent estimator at a frequency greater than or equal to a frequency of operation of the chaotic source.

7. The method of claim 1, wherein the verifying a plurality of parameters further comprises:
verifying an output of the raw entropy estimator is greater than or equal to an advertised rate of entropy.

8. The method of claim 1, wherein the verifying a plurality of parameters further comprises:
verifying an output of the Lyapunov exponent estimator is within a pre-specified range of an expected Lyapunov exponent.

9. The method of claim 8, further comprising:
defining the expected Lyapunov exponent during testing and from theoretical conditions.

10. The method of claim 1, wherein the verifying a plurality of parameters comprises:
verifying an actual entropy per symbol of the Lyapunov exponent estimator is greater than or equal to a predicted entropy per symbol of the Lyapunov exponent estimator.

11. The method of claim 1, wherein the method is implemented on a reconfigurable computing device comprising a Field Programmable Gate Array (FPGA).

12. A system (110) for evaluating randomly generated symbols comprising:
a chaotic system (110) for generating random symbols;
at least two estimators (120, 130) for evaluating an output of the chaotic system; and
a consistency checker (140) for verifying a plurality of parameters based on the outputs of the plurality of estimators.

13. The system of claim 12, further comprising:
a cryptographic conditioner for selectively utilizing the randomly generated symbols based on the verification.

14. The system of claim 12, wherein a first of the at least two estimators is a raw entropy estimator.

15. The system of claim 14, wherein an operating frequency of the raw entropy estimator is less than or equal to an operating frequency of the chaotic source.

16. The system of claim 12, wherein a second of the at least two estimators is a Lyapunov exponent estimator.

17. The system of claim 16, wherein an operating frequency of the Lyapunov exponent estimator is greater than or equal to an operating frequency of the chaotic source.

18. The system of claim 12, wherein the chaotic system is an optoelectronic system comprising a laser.

19. A method for generating an encryption key, the method comprising:
generating random symbols from a chaotic system;
evaluating an output of the chaotic system by a raw entropy estimator and by a Lyapunov exponent estimator;
verifying a plurality of parameters based on the on the outputs of the raw entropy estimator and the Lyapunov exponent estimator; and
selectively utilizing generated symbols based on the verification to encrypt data.

20. The method of claim 19, wherein the method is implemented on a reconfigurable computing device, the reconfigurable computing device including a field programmable gate array (FPGA)
